(19) United States
(12) Patent Application Publication
(10) Pub. No.: US 2025/0095260 A1
(43) Pub. Date: Mar. 20, 2025

(54) IMAGE PROCESSING METHOD AND APPARATUS, ELECTRONIC DEVICE AND STORAGE MEDIUM

(71) Applicant: Beijing ZItiao Network Technology Co., Ltd., Beijing (CN)

(72) Inventors: Wang LIU, Beijing (CN); Jiawei CHEN, Beijing (CN)

(21) Appl. No.: 18/882,642

(22) Filed: Sep. 11, 2024

(30) Foreign Application Priority Data
Sep. 15, 2023 (CN) 202311199427.4

(51) Int. Cl. G06T 13/40; G06T 13/20; G06T 17/20; G06V 40/16

(52) U.S. Cl. CPC G06T 13/40; G06T 13/205; G06T 17/20; G06V 40/171

(57) ABSTRACT

The embodiment of the disclosure provides an image processing method and apparatus, an electronic device and a storage medium, and the method includes: obtaining audio data and target part data corresponding to a target object; determining first to-be-fused data corresponding to the audio data; and determining second to-be-fused data corresponding to the target part data; and determining target fusion data based on the first to-be-fused data and the second to-be-fused data to drive a display of a target virtual object based on the target fusion data. According to the technical solution provided by the embodiment of the disclosure, the following technical effect is achieved: the audio information and the part data of the target object are processed online, target fusion data is determined, and a display of a three-dimensional virtual object is driven based on the target fusion data.

### CROSS-REFERENCE

This application claims priority to Chinese Patent Application No. 202311199427.4 filed on Sep. 15, 2023, and entitled “IMAGE PROCESSING METHOD AND APPARATUS, ELECTRONIC DEVICE AND STORAGE MEDIUM”, the entirety of which is incorporated herein by reference.

### FIELD

Embodiments of the present disclosure relate to the field of image processing technologies, and in particular, to an image processing method and apparatus, an electronic device, and a storage medium.

### BACKGROUND

With the development of computer technologies, more and more application software emerge, and users have more and more functional requirements on application software, and correspondingly, interaction requirements with terminal devices need to be improved.

At present, expression driving for virtual objects is mainly based on mouth shape information of a character, and when the mouth shape information is used, pronunciation of the character may be inaccurate, resulting in inaccurate expression driving. It may also be possible to record a mouth shape animation and then perform expression driving, at this time, online processing cannot be implemented, that is, there is a long lag and delay.

That is to say, the existing expression driving for the virtual objects cannot be implemented in real time and has a longer lag.

### SUMMARY

The present disclosure provides an image processing method and apparatus, an electronic device, and a storage medium, to drive a virtual object in real time to simulate a mouth shape and an expression corresponding to a target object, so as to achieve an effect of interaction realism and driving synchronism.

According to a first aspect, an embodiment of the present disclosure provides an image processing method, including:
obtaining audio data and target part data corresponding to a target object, wherein the target part data corresponds to position information and state information of a predetermined capture part;
determining first to-be-fused data corresponding to the audio data;
determining second to-be-fused data corresponding to the target part data; and
determining target fusion data based on the first to-be-fused data and the second to-be-fused data to drive a display of a target virtual object based on the target fusion data.

According to a second aspect, an embodiment of the present disclosure further provides an image processing apparatus, including:
a data obtaining module configured to obtain audio data and target part data corresponding to a target object;
a first data determining module configured to determine first to-be-fused data corresponding to the audio data; and
a second data determining module configured to determine second to-be-fused data corresponding to the target part data; and
a target fusion data determining module configured to determine target fusion data based on the first to-be-fused data and the second to-be-fused data to drive a display of a target virtual object based on the target fusion data.

According to a third aspect, an embodiment of the present disclosure further provides an electronic device, including:
one or more processors;
a storage device configured to store one or more programs;
the one or more programs, when executed by the one or more processors, causing the one or more processors to implement the image processing method according to any one of the embodiments of the present disclosure.

According to a fourth aspect, an embodiment of the present disclosure further provides a storage medium including computer executable instructions, the computer executable instructions, when executed by a computer processor, performing the image processing method according to any one of the embodiments of the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and components and elements are not necessarily drawn to scale.

FIG. 1 is a schematic flowchart of an image processing method according to an embodiment of the present disclosure;

FIG. 2 is a schematic flowchart of an image processing method according to an embodiment of the present disclosure;

FIG. 3 is a schematic structural diagram of an image processing apparatus according to an embodiment of the present disclosure;

FIG. 4 is a schematic structural diagram of an electronic device according to an embodiment of the present disclosure.

### DETAILED DESCRIPTION

Embodiments of the present disclosure will be described in more detail below with reference to the accompanying drawings. While some embodiments of the present disclosure are shown in the drawings, it shall be understood that the present disclosure can be implemented in various forms and should not be construed as limited to the embodiments set forth herein. On the contrary, these embodiments are provided for a more thorough and complete understanding of the present disclosure. It shall be understood that the drawings and embodiments of the present disclosure are provided for illustrative purposes only and are not intended to limit the scope of protection of the present disclosure.

It shall be understood that the steps recited in the method embodiments of the present disclosure may be performed in different orders and/or in parallel. Further, the method embodiments may include additional steps and/or the steps as shown may be omitted. The scope of this disclosure is not limited in this regard.

As used herein, the term “comprising” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It shall be noted that the concepts of “first” and “second” mentioned in this disclosure are only used to distinguish different devices, modules, or units, but are not used to limit the order or interdependence of the functions performed by these devices, modules, or units.

It should be noted that the modification of “one” and “a plurality” mentioned in this disclosure are illustrative but not limiting. Those skilled in the art should understand that unless otherwise indicated in the context, they should be understood as “one or more”.

The names of messages or information interaction between multiple devices in embodiments of the present disclosure are described for illustrative purposes only and are not intended to limit the scope of such messages or information.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It shall be understood that the above notification and user authorization process are only illustrative which do not limit the implementation of this disclosure. Other methods that meet relevant laws and regulations can also be applied to the implementation of this disclosure.

It may be understood that data involved in the technical solution (including but not limited to the data itself, the acquisition or use of the data) should follow the requirements of the corresponding laws, regulations and related regulations.

Before introducing the technical solution, the application scenario may be described first. The technical solution provided by the embodiments of the present disclosure may be applied to any scenario in which a display of a virtual object is driven based on voice and body part data of a target object, for example, it may be applied to a live streaming scenario, a video conference scenario, a video call scenario, and an effect presenting scenario, and a specific application scenario thereof is not specifically limited in the solutions provided by the embodiments of the present disclosure. The live streaming scenario may be a scenario in which items are sold through live streaming. For example, for a live streaming scenario, if a certain live streaming user does not want to appear in front of the camera, a virtual object may be created, and audio information and target part data corresponding to the live streaming object are obtained in real time during live streaming of the user. Through data analysis and processing, the effect of driving the mouth shape and the part display information of the virtual object to be in consistent with the live streaming user is achieved. It may also be an effect scenario, that is, an effect of the mouth shape data and the target part data of the target object being captured in real time to drive display of the virtual object is presented.

It should be noted that the foregoing describes various scenarios to which the above method can be applied, and details are not described herein again. The apparatus for performing the image method provided in the embodiments of the present disclosure may be integrated into application software that supports a video image processing function, and the software may be installed in an electronic device. Optionally, the electronic device may be a mobile terminal or a PC terminal, etc. The application software may be a type of software for image/video processing, and the specific application software thereof is not described in detail herein, as long as image/video processing may be implemented.

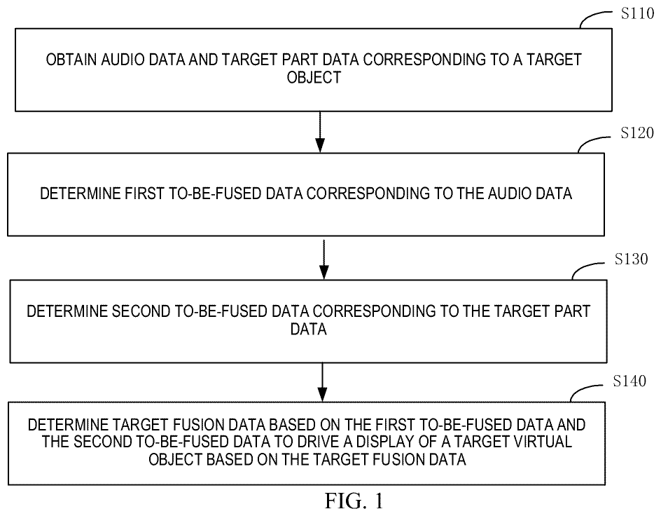

FIG. 1 is a schematic flowchart of an image processing method according to an embodiment of the present disclosure. Embodiments of the present disclosure are applicable in any situation where a virtual object needs to be driven for anthropomorphic display, and the method may be performed by an image processing apparatus, which may be implemented in the form of software and/or hardware; and optionally, the method may be performed by an electronic device, which may be a mobile terminal, a PC, or a server, and the like.

As shown in FIG. 1, the method includes:

At S110, audio data and target part data corresponding to a target object are obtained.

Generally, when a display of a three-dimensional virtual object is driven, a corresponding reference basis is required, that is, which object is used as a prototype for display, the prototype may be used as the target object. For example, if a mouth shape and an expression of the virtual object displayed in real time correspond to a user A, the audio data and the target part data of the user A may be obtained, and at this time, the user A may be used as the target object. In a process that the target object is speaking, corresponding audio information may be captured in real time and used as audio data. Correspondingly, in the process that the target object is speaking, usually there are different expressions, in order to achieve a realistic display effect for the virtual object, target part data of different parts in a face image of the target object may be obtained in the process that the target object is speaking. That is, the target part data is data corresponding to different five sense organs on the face of the target object. Of course, the target part data may be data corresponding only to at least one of an eyebrow part, a nose part, an eye part, a mouth part, and an ear part.

Specifically, the audio data corresponding to the target object may be captured in real time based on the deployed microphone array, and the target part data of a target part may be captured based on the face image captured device.

It should be further noted that the target part corresponding to the target part data may be predetermined, or may be determined based on a triggering selection on the target object, and the specific selection manner of the target part is not limited in the embodiments of the present disclosure, which may be selected according to actual needs.

The target part data corresponds to position information and state information of a predetermined capture part, wherein the predetermined capture part may be a predetermined part, optionally, the predetermined capture part may be a part among face parts, such as, a nose, an eyebrow, a mouth, and an eye. The position information may be a specific position of each part on the face, and the state may be an open or closed state.

Optionally, the capturing audio data and target part data corresponding to a target object includes: in response to a virtual object driving operation, capturing audio information corresponding to the target object based on an audio capture device; and capturing the target part data corresponding to the target object based on a face image capture device; wherein a part corresponding to the target part data comprises at least one part of the five sense organs.

It shall be understood that whether to drive the virtual object is determined based on an actual requirement of the target object. When it is detected that the virtual object driving operation is triggered, the audio data and the target part data of the target object may be captured. The audio information of the target object may be captured based on devices such as a smart speaker, an intelligent robot, a chat robot, and a microphone array. The audio data is output in a wired or wireless manner. The face image capture device may be a camera device, and the camera device may be a depth camera or the like. If the target part is one or more predetermined parts, feature data of one or more parts may be extracted as the target part data after the facial image is captured. If the target part is not predetermined, the captured whole face image data may be used as the target part data.

At S120, first to-be-fused data corresponding to the audio data is determined.

It should be noted that, the audio data is the most original data captured, and in order to drive the facial image of the virtual object to be consistent with the target object, the audio data may be further analyzed and processed to obtain the first to-be-fused data. In other words, the first to-be-fused data is corresponding data after the audio data analysis processing.

In this embodiment, determining the first to-be-fused data corresponding to the audio data includes: determining a plurality of characters corresponding to the audio data, and determining pronunciation information corresponding to the plurality of characters; and determining first to-be-fused data of a mouth part based on the pronunciation information.

The audio data is the most original voice information captured. The audio data may be parsed and processed by a speech-to-text module to obtain text information corresponding to the audio data. At this time, the text information and sentence semantic may be analyzed to determine pronunciation information corresponding to each character. In this way, the problem that the first to-be-fused data is inaccurately determined due to inaccurate pronunciation of the target object is avoided. The mouth shape data may be determined based on the pronunciation information, and the mouth shape data is used as the first to-be-fused data.

It should also be noted that, the virtual object is usually a three-dimensional virtual object. In order to make mouth display information of a virtual object to be consistent with mouth display information of the target object, the face may be divided into a plurality of meshes in advance, that is, the face is composed of a plurality of patches. Mesh data corresponding to each mesh may be determined based on the audio data. That is, the first to-be-fused data is mesh point data into which the voice information is converted after processing.

At S130, second to-be-fused data corresponding to the target part data is determined.

The target part data is data matching a predetermined target part. The second to-be-fused data is data obtained after processing the target part data.

In this embodiment, determining the second to-be-fused data corresponding to the target part includes: determining mesh point data of a plurality of meshes corresponding to the target part based on the target part data; and determining the mesh point data as the second to-be-fused data.

Based on S120, it can be known that the virtual object is a three-dimensional virtual object, in order to achieve a three-dimensional and realistic display effect, the face area can be divided into a plurality of mesh areas, and an area covered by the mesh areas is consistent with the face area of the three-dimensional virtual object. Based on the captured facial image data, mesh point data corresponding to the mesh points of each mesh may be determined. The mesh point data determined at this time is used as the second to-be-fused data.

It should also be noted that the target part data corresponds to at least one face part, the integration of the face parts may correspond to the facial expression of the target object, and correspondingly, the target part data corresponds to the facial expression of the target object. That is, the target part data is facial expression data in the process that the target object is speaking.

At S140, target fusion data is determined based on the first to-be-fused data and the second to-be-fused data, to drive a display of a target virtual object based on the target fusion data.

The target fusion data is data obtained after the first to-be-fused data and the second to-be-fused data are fused. In this case, the target fusion data includes the processed mouth shape data and the processed facial expression data.

Specifically, the first to-be-fused data and the second to-be-fused data may be fused according to a predetermined rule to obtain target fusion data corresponding to the mouth shape and the facial expression of the target object. After the target fusion data is obtained, a display of the target virtual object may be driven, and at this time, the mouth shape and the facial expression of the target virtual object match the mouth shape and the facial expression of the target object.

According to the technical solution provided by the embodiment of the present disclosure, the audio data and the target part data of the target object can be captured in real time, through determining the mouth shape data analyzing audio data, and determining the facial expression data by analyzing the target part data, the mouth shape data and the facial expression data are further fused, and the target fusion data for driving the target virtual object is obtained, thus the following problem in the prior art is solved: the expression driving cannot be performed on the virtual object in real time and thus there is a long lag, thereby realizing the technical effect of performing analysis processing on the capture data in real time, so as to achieve synchronous driving for the target virtual object.

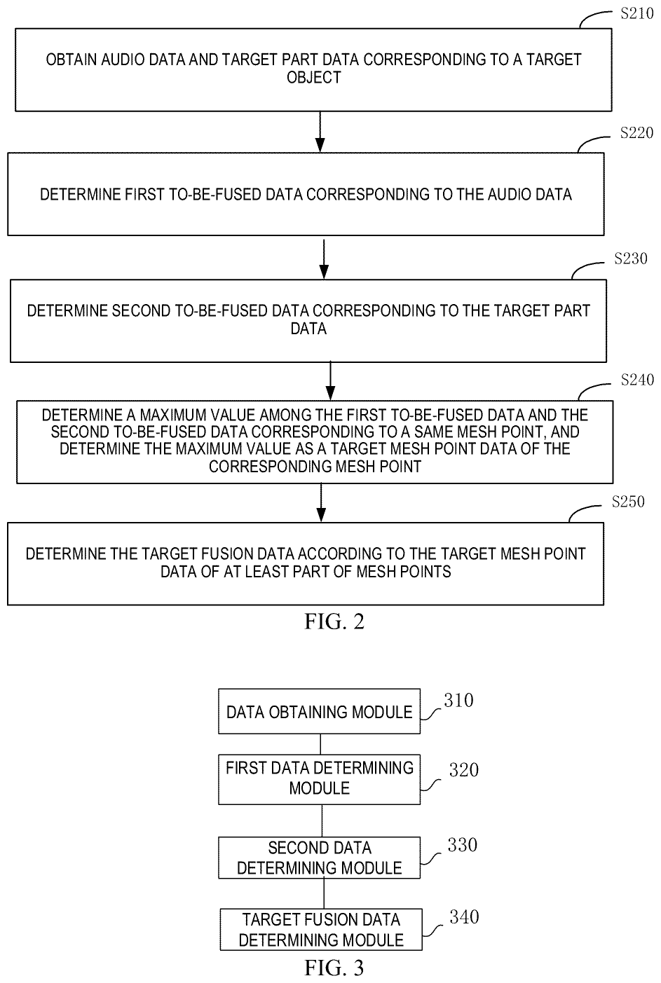

FIG. 2 is a schematic flowchart of an image processing method according to a second embodiment of the present disclosure, on the basis of the foregoing embodiments, how to determine the target fusion data may be further explained, and a specific implementation thereof may refer to the detailed description of this embodiment, and technical terms that are the same as or corresponding to the foregoing embodiments are not described herein again.

As shown in FIG. 2, the method includes:

At S210, audio data and target part data corresponding to the target object are obtained.

For example, in a live streaming scenario, in a live streaming process of a target object, audio data and face data corresponding to the target object, that is, audio data and target part data, may be captured in real time.

At S220, first to-be-fused data corresponding to the audio data is determined.

The mouth shape data corresponding to the audio information, that is, the first to-be-fused data, is determined by analyzing the audio data. The first to-be-fused data may be composed of 52 blendshape (single mesh point) data. That is, after the audio data is analyzed, mouth shape data and rough expression data are obtained by fitting.

At S230, second to-be-fused data corresponding to the target part data is determined.

In a process of determining the first to-be-fused data, the target part data may also be analyzed to obtain 52 blendshape data corresponding to the facial expression. That is, the data at this time is facial expression data determined directly based on the captured target part data.

At S240, a maximum value among the first to-be-fused data and the second to-be-fused data corresponding to a same mesh point is determined, and the maximum is determined as a target mesh point data of the corresponding mesh point.

It can be understood that, for each mesh point, the data processing manner is the same, which is described herein by taking determination of mesh data of one mesh point as an example.

It should be further noted that the number of mesh points corresponding to the first to-be-fused data determined based on the audio information is the same as the number of mesh points corresponding to the second to-be-fused data determined based on the audio information, but the focus of the data are different.

Specifically, for data corresponding to the same mesh point, the maximum value among the first to-be-processed fusion data and the second to-be-processed fusion data is determined, and the maximum value is determined as the target mesh data of the corresponding mesh point.

For example, two sets of data are obtained based on the foregoing steps, where, the first set of data, that is the first to-be-fused data, is mouth-shape blendshape data, and the other set of data, that is, the second to-be-fused data, is expression blendshape data. For each blendshape data, a maximum value is selected as the target fusion data corresponding to the corresponding blendshape data.

At S250, the target fusion data is determined according to the target mesh point data of at least part of mesh points.

That is, the target fusion data includes target mesh point data of each mesh point. Based on this target fusion data, a display of the target virtual object may be driven to achieve the effect of driving the display in real time, and the specific display may refer to the description of the above embodiments. At least some of the mesh points may be all mesh points or a part of mesh points.

In practical applications, when a display of the virtual object is driven based on the target fusion data at this time, there may be a phenomenon that the target virtual object has a facial expression and a mouth shape that are jumping or unstable in the process that the target virtual object is speaking, and the target mesh point data of each target mesh point may be processed based on the fusion curve to obtain the target fusion data.

The fusion curve may correspond to different predetermined facial expression. The fusion curve may include fusion values corresponding to different predetermined expressions at respective mesh points. The fusion curve may also be several video frames before the current frame, and the fusion value corresponding to each mesh point is updated according to the mesh point data of the first several video frames.

In other words, after the target fusion data is obtained, the target fusion data can be finely adjusted based on the fusion curve, so that the continuity and stability of expression change of the virtual object in the continuous video frames are ensured, and the real time state of the target virtual object can be more accurately represented.

For example, in order to avoid data jumping and unstable phenomena, after determining the target fusion data, the target fusion data is subjected to a curve change, that is, the target fusion data is finely adjusted in combination with the historical target fusion data corresponding to the previous video frame, to update the target fusion data. When the target virtual object is displayed based on the target fusion data obtained at this time, the continuity and stability of the expression are ensured, and meanwhile, the real time state of the target virtual object can be accurately represented.

According to the technical solution provided by the embodiment of the present disclosure, the audio data and the target part data of the target object can be captured in real time, through determining the mouth shape data analyzing audio data, and determining the facial expression data by analyzing the target part data, the mouth shape data and the facial expression data are further fused, and the target fusion data for driving the target virtual object is obtained, thus the following problem in the prior art is solved: the expression driving cannot be performed on the virtual object in real time and thus there is a long lag, thereby realizing the technical effect of performing analysis processing on the captured data in real time, so as to achieve synchronous driving for the target virtual object.

FIG. 3 is a schematic structural diagram of an image processing apparatus according to an embodiment of the present disclosure. As shown in FIG. 3, the apparatus includes: a data obtaining module 310, a first data determining module 320, a second data determining module 330, and a target fusion data determining module 340.

The data obtaining module 310 is configured to obtain audio data and target part data corresponding to a target object; where the target part data corresponds to position information and state information of a predetermined capture part; the first data determining module 320 is configured to determine first to-be-fused data corresponding to the audio data; and a second data determining module 330 is configured to determine second to-be-fused data corresponding to the target part data; and a target fusion data determining module 340 is configured to determine target fusion data based on the first to-be-fused data and the second to-be-fused data to drive a display of a target virtual object based on the target fusion data.

On the basis of the above technical solution, the data obtaining module includes:
an audio data capturing unit, configured to capture, in response to a virtual object driving operation, audio information corresponding to the target object based on an audio capture device; and a part data capturing unit, configured to the target part data corresponding to the target object based on a face image capturing device, where a part corresponding to the target part data includes at least one part of the five sense organs.

Based on the foregoing technical solutions, the first data determining module includes:
a pronunciation information determining unit, configured to determine a plurality of pieces of text information corresponding to the audio data, and determine pronunciation information corresponding to the plurality of pieces of text information; and a first fusion unit, configured to determine first to-be-fused data of a mouth part based on the pronunciation information.

On the basis of the foregoing technical solutions, the second data determining module includes:
a mesh point data determining unit, configured to determine mesh point data of a plurality of meshes corresponding to the target part based on the target part data; and a second fusing unit, configured to determine the mesh point data as the second to-be-fused data.

Based on the foregoing technical solutions, the target fusion data determining module includes:
a mesh point data determining unit, configured to determine a maximum value among the first to-be-fused data and the second to-be-fused data corresponding to a same mesh point, and determine the maximum value as a target mesh point data of the corresponding mesh point; and a target fusing unit, configured to determine the target fusion data according to the target mesh point data of at least part of mesh points.

On the basis of the foregoing technical solutions, the target fusing unit includes:
an superimpose fusing subunit, configured to determine to-be-superimposed fusion data of the target mesh point by processing the target mesh point data according to a predetermined fusion curve; and a target fusing subunit, configured to update the target fusion data based on to-be-superimposed fusion data.

Based on the foregoing technical solutions, the fusion curve corresponds to a predetermined facial expression.

Based on the foregoing technical solutions, the apparatus further includes: a driving module, configured to update a facial expression and a mouth shape of the target virtual object based on the target fusion data, so that the facial expression and the mouth shape of the target virtual object correspond to those of the target object.

According to the technical solution provided by the embodiment of the present disclosure, the audio data and the target part data of the target object can be captured in real time, through determining the mouth shape data analyzing audio data, and determining the facial expression data by analyzing the target part data, the mouth shape data and the facial expression data are further fused, and the target fusion data for driving the target virtual object is obtained, thus the following problem in the prior art is solved: the expression driving cannot be performed on the virtual object in real time and thus there is a long lag, thereby realizing the technical effect of performing analysis processing on the captured data in real time, so as to achieve synchronous driving for the target virtual object.

The image processing apparatus provided by the embodiments of the present disclosure may perform the image processing method provided by any embodiment of the present disclosure, and has corresponding functional modules and beneficial effects for implementing the method.

It should be noted that the units and modules included in the foregoing apparatus are only divided according to functional logic, but are not limited to the foregoing division, as long as corresponding functions can be implemented; in addition, specific names of the functional units are merely for ease of distinguishing, and are not intended to limit the protection scope of the embodiments of the present disclosure.

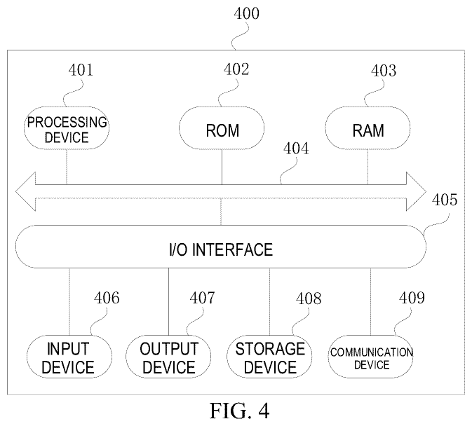

FIG. 4 is a schematic structural diagram of an electronic device according to an embodiment of the present disclosure. Referring to FIG. 4, it illustrates a schematic structural diagram of an electronic device (such as the terminal device or server in FIG. 4) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 4 is merely an example, and should not impose any limitation on the functions and scope of use of the embodiments of the present disclosure.

As shown in FIG. 4, the electronic device 400 may include a processing device (for example, a central processing unit, a graphics processor, etc.) 401, which may perform various appropriate actions and processing according to a program stored in a read-only memory (ROM) 402 or a program loaded into a random-access memory (RAM) 403 from a storage device 408. In the RAM 403, various programs and data required by the operation of the electronic device 400 are also stored. The processing device 401, the ROM 402, and the RAM 403 are connected to each other through a bus 404. An edit/output (I/O) interface 405 is also connected to the bus 404.

Generally, the following devices may be connected to the I/O interface 405: an input device 406 including, for example, a touch screen, a touchpad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to communicate wirelessly or wired with other devices to exchange data. While FIG. 4 shows an electronic device 400 having various devices, it should be understood that the electronic device is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product, which includes a computer program carried on a non-transitory computer readable medium, the computer program including program code for performing the method shown in the flowchart. In such embodiments, the computer program may be downloaded and installed from the network through the communication device 409, or installed from the storage device 408, or installed from the ROM 402. When the computer program is executed by the processing device 401, the foregoing functions defined in the method of the embodiments of the present disclosure are performed.

The names of messages or information interaction between a plurality of devices in embodiments of the present disclosure are for illustrative purposes only and are not intended to limit the scope of such messages or information.

The electronic device provided by the embodiments of the present disclosure and the image processing method provided in the above embodiments belong to the same inventive concept, technical details not described in detail in this embodiment may refer to the foregoing embodiments, and the present embodiment has the same beneficial effects as the foregoing embodiments.

An embodiment of the present disclosure provides a computer storage medium having a computer program stored thereon, the program, when executed by a processor, implements the image processing method provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or propagated as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client and the server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device:
obtain audio data and target part data corresponding to a target object, wherein the target part data corresponds to position information and state information of a predetermined capture part;
determine first to-be-fused data corresponding to the audio data;
determine second to-be-fused data corresponding to the target part data; and
determine target fusion data based on the first to-be-fused data and the second to-be-fused data to drive a display of a target virtual object based on the target fusion data.

Computer program codes for performing the operations of the present disclosure may be written in one or more programming languages or a combination thereof, including, but not limited to, Object Oriented programming languages—such as Java, Smalltalk, C++, and conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including Local Area Network (LAN) or Wide Area Network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

According to one or more embodiments of the present disclosure, [Example 1] provides an image processing method, including:
obtaining audio data and target part data corresponding to a target object, wherein the target part data corresponds to position information and state information of a predetermined capture part;
determining first to-be-fused data corresponding to the audio data;
determining second to-be-fused data corresponding to the target part data; and
determining target fusion data based on the first to-be-fused data and the second to-be-fused data to drive a display of a target virtual object based on the target fusion data.

According to one or more embodiments of the present disclosure, [Example 2] provides an image processing method, including:

Optionally, obtaining the audio data and the target part data corresponding to the target object includes:
in response to a virtual object driving operation, capturing audio information corresponding to the target object based on an audio capture device; and
capturing the target part data corresponding to the target object based on a face image capture device;
wherein a part corresponding to the target part data comprises at least one part of the five sense organs.

According to one or more embodiments of the present disclosure, [Example 3] provides an image processing method, including:

Optionally, determining the first to-be-fused data corresponding to the audio data includes:
determining a plurality of pieces of text information corresponding to the audio data, and determining pronunciation information corresponding to the plurality of pieces of text information; and
determining first to-be-fused data of a mouth part based on the pronunciation information.

According to one or more embodiments of the present disclosure, [Example 4] provides an image processing method, including:
optionally, determining the second to-be-fused data corresponding to the target part includes:
determining mesh point data of a plurality of meshes corresponding to the target part based on the target part data; and
determining the mesh point data as the second to-be-fused data.

According to one or more embodiments of the present disclosure, [Example 5] provides an image processing method, including:

Optionally, determining the target fusion data based on the first to-be-fused data and the second to-be-fused data includes:
determining a maximum value among the first to-be-fused data and the second to-be-fused data corresponding to a same mesh point, and determining the maximum value as a target mesh point data of the corresponding mesh point; and
determining the target fusion data according to the target mesh point data of at least part of mesh points.

According to one or more embodiments of the present disclosure, [Example 6] provides an image processing method, including:

Optionally, determining the target fusion data according to the target mesh point data of at least part of the mesh points includes:
determining to-be-superimposed fusion data of the target mesh point by adjusting the target mesh point data according to a predetermined fusion curve; and
updating the target fusion data based on the to-be-superimposed fusion data.

According to one or more embodiments of the present disclosure, [Example 7] provides an image processing method, including:

Optionally, the fusion curve corresponds to a predetermined facial expression.

According to one or more embodiments of the present disclosure, [Example 8] provides an image processing method, including:

Optionally, updating a facial expression and a mouth shape of the target virtual object based on the target fusion data, so that the facial expression and the mouth shape of the target virtual object correspond to those of the target object.

According to one or more embodiments of the present disclosure, [Example 9] provides an image processing method, including:
a data obtaining module configured to obtain audio data and target part data corresponding to a target object;
a first data determining module configured to determine first to-be-fused data corresponding to the audio data; and
a second data determining module configured to determine second to-be-fused data corresponding to the target part data; and
a target fusion data determining module configured to determine target fusion data based on the first to-be-fused data and the second to-be-fused data to drive a display of a target virtual object based on the target fusion data.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it shall be understood that the subject matter defined in the appended claims is not necessarily limited to the specific features or actions described above. On the contrary, the specific features and actions described above are merely example forms of implementing the claims.

I/we claim:

1. An image processing method, comprising:
obtaining audio data and target part data corresponding to a target object, wherein the target part data corresponds to position information and state information of a predetermined capture part;
determining first to-be-fused data corresponding to the audio data;
determining second to-be-fused data corresponding to the target part data; and
determining target fusion data based on the first to-be-fused data and the second to-be-fused data to drive a display of a target virtual object based on the target fusion data.

2. The method of claim 1, wherein obtaining the audio data and the target part data corresponding to the target object comprises:
in response to a virtual object driving operation, capturing audio information corresponding to the target object based on an audio capture device; and
capturing the target part data corresponding to the target object based on a face image capture device,
wherein a part corresponding to the target part data comprises at least one part of the five sense organs.

3. The method of claim 1, wherein determining the first to-be-fused data corresponding to the audio data comprises:
determining a plurality of pieces of text information corresponding to the audio data, and determining pronunciation information corresponding to the plurality of pieces of text information; and
determining first to-be-fused data of a mouth part based on the pronunciation information.

4. The method of claim 1, wherein determining the second to-be-fused data corresponding to the target part comprises:
determining mesh point data of a plurality of meshes corresponding to the target part based on the target part data; and
determining the mesh point data as the second to-be-fused data.

5. The method of claim 1, wherein determining the target fusion data based on the first to-be-fused data and the second to-be-fused data comprises:
determining a maximum value among the first to-be-fused data and the second to-be-fused data corresponding to a same mesh point, and determining the maximum value as a target mesh point data of the corresponding mesh point; and
determining the target fusion data according to the target mesh point data of at least part of mesh points.

6. The method of claim 5, wherein determining the target fusion data according to the target mesh point data of at least part of the mesh points comprises:
determining to-be-superimposed fusion data of the target mesh point by adjusting the target mesh point data according to a predetermined fusion curve; and
updating the target fusion data based on the to-be-superimposed fusion data.

7. The method of claim 6, wherein the fusion curve corresponds to a predetermined facial expression.

8. The method of claim 1, further comprising:
updating a facial expression and a mouth shape of the target virtual object based on the target fusion data, so that the facial expression and the mouth shape of the target virtual object correspond to those of the target object.

9. An electronic device, comprising:
one or more processors; and
a storage device configured to store one or more programs;
wherein the one or more programs, when executed by the one or more processors, cause the one or more processors to implement acts comprising:
obtaining audio data and target part data corresponding to a target object, wherein the target part data corresponds to position information and state information of a predetermined capture part;
determining first to-be-fused data corresponding to the audio data;
determining second to-be-fused data corresponding to the target part data; and
determining target fusion data based on the first to-be-fused data and the second to-be-fused data to drive a display of a target virtual object based on the target fusion data.

10. The device of claim 9, wherein obtaining the audio data and the target part data corresponding to the target object comprises:
in response to a virtual object driving operation, capturing audio information corresponding to the target object based on an audio capture device; and
capturing the target part data corresponding to the target object based on a face image capture device,
wherein a part corresponding to the target part data comprises at least one part of the five sense organs.

11. The device of claim 9, wherein determining the first to-be-fused data corresponding to the audio data comprises:
determining a plurality of pieces of text information corresponding to the audio data, and determining pronunciation information corresponding to the plurality of pieces of text information; and
determining first to-be-fused data of a mouth part based on the pronunciation information.

12. The device of claim 9, wherein determining the second to-be-fused data corresponding to the target part comprises:
determining mesh point data of a plurality of meshes corresponding to the target part based on the target part data; and
determining the mesh point data as the second to-be-fused data.

13. The device of claim 9, wherein determining the target fusion data based on the first to-be-fused data and the second to-be-fused data comprises:
determining a maximum value among the first to-be-fused data and the second to-be-fused data corresponding to a same mesh point, and determining the maximum value as a target mesh point data of the corresponding mesh point; and
determining the target fusion data according to the target mesh point data of at least part of mesh points.

14. The device of claim 13, wherein determining the target fusion data according to the target mesh point data of at least part of the mesh points comprises:
determining to-be-superimposed fusion data of the target mesh point by adjusting the target mesh point data according to a predetermined fusion curve; and
updating the target fusion data based on the to-be-superimposed fusion data.

15. The device of claim 14, wherein the fusion curve corresponds to a predetermined facial expression.

16. The device of claim 9, wherein the acts further comprise:
updating a facial expression and a mouth shape of the target virtual object based on the target fusion data, so that the facial expression and the mouth shape of the target virtual object correspond to those of the target object.

17. A non-transitory storage medium comprising computer executable instructions, wherein the computer executable instructions, when executed by a computer processor, implements acts comprising:
obtaining audio data and target part data corresponding to a target object, wherein the target part data corresponds to position information and state information of a predetermined capture part;
determining first to-be-fused data corresponding to the audio data;
determining second to-be-fused data corresponding to the target part data; and
determining target fusion data based on the first to-be-fused data and the second to-be-fused data to drive a display of a target virtual object based on the target fusion data.

18. The medium of claim 17, wherein obtaining the audio data and the target part data corresponding to the target object comprises:
in response to a virtual object driving operation, capturing audio information corresponding to the target object based on an audio capture device; and
capturing the target part data corresponding to the target object based on a face image capture device,
wherein a part corresponding to the target part data comprises at least one part of the five sense organs.

19. The medium of claim 17, wherein determining the first to-be-fused data corresponding to the audio data comprises:
determining a plurality of pieces of text information corresponding to the audio data, and determining pronunciation information corresponding to the plurality of pieces of text information; and
determining first to-be-fused data of a mouth part based on the pronunciation information.

20. The medium of claim 17, wherein determining the second to-be-fused data corresponding to the target part comprises:
determining mesh point data of a plurality of meshes corresponding to the target part based on the target part data; and
determining the mesh point data as the second to-be-fused data.
